(19) United States
(12) Patent Application Publication
(10) Pub. No.: US 2024/0212479 A1
(43) Pub. Date: Jun. 27, 2024

(54) EMERGENCY CALL METHOD AND DEVICE

(71) Applicant: Thorn Security Limited, Middlesex (GB)

(72) Inventors: Martin COLE, Sunbury-On-Thames (GB); Faruk MEAH, Woking (GB)

(21) Appl. No.: 18/548,783

(22) PCT Filed: Mar. 4, 2022
(86) PCT No.: PCT/GB2022/050588

§ 371 Date: Sep. 1, 2023

(30) Foreign Application Priority Data
Mar. 4, 2021 (GB) 2103074.7

(51) Int. Cl. G08B 25/12; G08B 5/38

(52) U.S. Cl. CPC G08B 25/12; G08B 5/38

(57) ABSTRACT

An emergency call device (“ECD”) is described that can be fitted into pre-programmed fire detection zones of a building. During an emergency, occupants are prompted to press a button on a nearby ECD, indicating to a controller the occupants' presence at that location.

### BACKGROUND

Searching a burning building is one of the most important and dangerous aspects of a firefighter's job. A search must be conducted at every fire to which fire-fighters respond. Searches can be divided into two basic types: primary and secondary. These searches are different and require different tactics. Both can be, at times, extremely dangerous.

The first goal of the primary search is to find the fire, so that the search crew can prioritize the areas in need of search and work back, or away, from the fire.

Once the fire is in check, a search for victims can begin. This secondary search is a complete search of the entire premises for all possible points of fire extension and all possible victims. It is only reporting from residents and witnesses that informs this search.

### SUMMARY

An emergency call device (“ECD”) is described that can be fitted into pre-programmed fire detection zones of a building. This device has an alert light that flashes when a fire or other emergency condition has been detected and an alarm generated, and an occupant-activated button or switch.

During an emergency, occupants in identified zones are prompted to press the button on a nearby ECD, indicating to a controller, e.g., a fire alarm control panel, the occupants' presence at that location, thereby enabling the prioritization of occupied zones that should be investigated/evacuated by emergency personnel such as fire fighters, first responders and the like.

According to an embodiment, an ECD comprises a visual indicator, a button, a communication connection to a hazard alarm panel, and control circuitry. The control circuitry is configured to, in a first state, keep the visual indicator off. In this first state, upon receiving an alert signal from the panel, the control circuitry transitions to a second state and causes the visual indicator to flash on and off at a pre-determined human-perceptible rate. When an occupant presses or otherwise activates the button, the control circuitry transitions to a third state and causes the transmission of a presence signal to the hazard alarm panel and turns the visual indicator steady on. Alternatively, there may be a second visual indicator to indicate the signal has been transmitted. The ECD may include a building mount by which it can be fitted in a fixed manor to a building in a location. The building mount might be a wall mount by which the ECD is fixedly mounted to a wall, or a floor-standing mount by which the ECD is fixedly mounted to the floor.

The communication connection may be at least one of wired, wireless and optical.

The visual indicator(s) may comprise at least one LED each.

An ECD may further comprise a sound generator that may itself comprise at least one of a buzzer or a speaker. The control circuitry may be further configured to cause the sound generator to sound, e.g., buzz, upon receiving the alert signal from the hazard alarm panel and to silence the sound generator upon detecting activation the manual control. The sound must be at a level high enough to catch the attention of any occupant in the area to alert them as to the location of the ECD. The ECD may also comprise a camera to permit visual communication.

According to yet another embodiment of the invention, a fire alarm system comprises a fire alarm control panel (FACP), at least one zone-occupied alert unit (ECD) at at least one location, and a communication link communicatively linking the FACP and the ECD.

Upon the FACP detecting an emergency condition, the FACP may transmit an alert signal to the ECD via the communication link. The ECD may comprise a visual indicator, a manual control, and control circuitry. The control circuitry may be configured to cause the visual indicator to flash at a first pre-determined human-perceptible rate upon receiving the alert signal. The ECD, upon detecting activation of the manual control, may transmit to the FACP an “occupant-present” signal via the communication link.

Further, upon receiving the occupant-present signal, the FACP may provide an indication of the presence of a person at the location of the ECD, for example by using a visual or text display on the FACP. The FACP may also transmit a message to any of first responders, firefighters, or a command or monitoring center. Also, if there is no one at the FACP to handle communication with the person at the ECD, the message or communication can be diverted to the monitoring centre.

The fire alarm system may further comprise a loop coupled to the FACP communicatively connecting the FACP to initiating devices and/or notification appliances, wherein the loop also serves as the communication link between the FACP and the ECD.

Further still, the fire alarm system may comprise at least one of a door monitor, e.g., door contacts, and a hallway monitor such as a motion detector, in communication with the FACP. When the FACP receives an indication from one of the door and hallway monitors, it may transmit a message to the ECD indicating that the control circuitry should cause the visual indicator to flash at a second predetermined rate.

A method according to an embodiment of the present invention comprises the steps of: detecting, at a fire alarm control panel (FACP), an emergency condition; upon said detecting, the FACP transmitting an alert signal to at least zone-occupied alarm units (ECDs) in a vicinity of the detected emergency condition. Each ECD may comprise a visual indicator, and a manual control. Each ECD, upon receiving the alert signal, may flash its respective visual indicator at a pre-determined human-perceptible rate. Each ECD, upon detecting activation of its manual control, may transmit an occupant-present signal to the FACP. Upon receiving the occupant-present signal from one or more ECDs, the FACP may indicate the presence of a person at each location from which an ECD-transmitted occupant-present signal was received. The FACP may indicate the presence of a person by at least one of: displaying text or graphic; or transmitting a message to any of first responders, firefighters, or a command or monitoring center.

### BRIEF DESCRIPTION OF THE DRAWINGS

FIG. 1 is a drawing illustrating an exemplary ECD according to embodiment of the present invention.

FIG. 2 is a schematic diagram of a first configuration of a fire detection system employing embodiments of the present invention.

FIG. 3 is a schematic diagram of a second configuration of a fire detection system employing embodiments of the present invention.

FIG. 4 is a state diagram illustrating the operation of an exemplary ECD.

FIG. 5 is a block diagram of a first embodiment ECD.

FIG. 6 is a block diagram of a second embodiment ECD.

FIG. 7 is a schematic illustrating for exemplary purposes a simple first floor layout of a multi-level building in which embodiments of the present invention have been deployed.

### DESCRIPTION

According to embodiments of the present invention, in order to assist with secondary searches for fire victims, each zone within a fire detection system or other emergency detection and notification system may be fitted with one or more emergency call devices (ECDs), fixed at locations within a building, by which occupants may signal their presence in a specified area or zone. An ECD may comprise an alert light and button in a wall mounted box, preferably located close to the nearest fire escape or other egress. Alternatively, the ECD may include a floor-standing box by which the ECD is fixedly mounted to the floor.

Typically, upon arrival to a building in alarm, a fireman goes to the panel, identifies where the fire is, proceeds to the area (if possible) and puts out the fire. If an occupant is in that area, it is likely that the fireman would see that person and provide assistance. However, if a person is in another area or zone where there is no alarm, she may still be in danger (doors locked, disabled, can't access exit or elevator).

Preferably, there is a hierarchy of messages at the FACP. For example, the FACP may configured such that smoke and fire alarms get highest priority, while emergency calls may be the next priority; and perhaps CO detection may be yet a lower priority since it may be more important to reach an occupant before they suffer from CO poisoning and then find the cause.

With all the alarms going off and the physical and aural commotion, it is desirable to have emergency calls stand out to get a responder's attention.

Further, the FACP may notify an alarm receiving center/central monitoring station of an emergency call using auto-dialup modem, Internet, or other means. The monitoring station may in response notify one or more responders.

In another scenario, an occupant may be in a zone or location where there is no alarm, for example if the occupant is some distance away from the emergency in an area not perceived by the system as threated; or even when there is no alarm, but the occupant is in distress. In this scenario, the location of an ECD is valuable because it allows the occupant the ability to make contact with someone who can help with their distressed situation. The occupant can activate the button on the ECD to alert someone to their situation. The alert can be routed through any building management system, such as a fire alarm system access control system or the like to a responder with authority to handle the situation. That responder might be on-site, or in a remote monitoring station. The system is set up to direct the alert to an appropriate place. The occupant is able to conduct a conversation with the responder to address the situation. If the ECD has a camera, the responder is able to gain more visual information from the camera's video feed.

The visual indicator may indicate that an occupant-present signal has been received acknowledged automatically by the panel, for example by turning steady on. Alternatively, or in addition, the visual indicator may be used to indicate that a person at the panel or in communication with the panel has been aware of the occupant's presence in a location and has manually acknowledge. This may also be implemented as a second visual indicator.

Alternatively, a speaker and microphone may be implemented on the ECD, such that it behaves like an intercom, allowing the occupant to verbally communicate with a responder via the panel. This requires a secondary system: a) another pair of wires; or b) wireless—in order for the occupant to talk to someone at panel. Another mode of communication may be to install a SIM in the ECD. The panel would be configured to recognize the SIM's ID. A camera might also be included to facilitate communication, and to give a responder visual information about the location and about the person at the panel.

The ECDs may be connected to a fire panel, preferably on the same wiring loop as fire/smoke or other hazardous condition detectors.

A ECD may become active, e.g., by flashing its alert light (visual indicator), when a fire alarm has been generated, for example by a fire panel in response to an activated call point (pull station) or hazard detector. When the ECD button is pushed, the ECD may latch (for example, the light stops flashing and is on steady) and a signal may be sent to the fire panel to indicate the presence of occupants in that zone. This is designed to assist fire fighters in prioritizing their search procedure. Occupied zones can then be searched, and their respective devices deactivated as they have been checked and cleared.

A ECD may have at least three states. In a first state, the zone is not in alarm and the visual indicator is off. In a second state, a fire or other hazard has been detected and an alarm generated. The visual indicator may flash to get occupants' attention. In a third state, someone has pressed the button on the ECD and the visual indicator may be steady on.

Hazardous conditions may include any, but is not limited to, the following: smoke, fire, heat, CO, CO₂, radiation, natural gas and other toxic chemicals, active shooter, etc.

The visual indicator may comprise one or more LEDs or incandescent bulbs, or may be combined with a button or a touchscreen.

The button may be, for example, a mechanical pushbutton, toggle switch, touchscreen, etc. The visual indicator may be located within, around, or adjacent to the button.

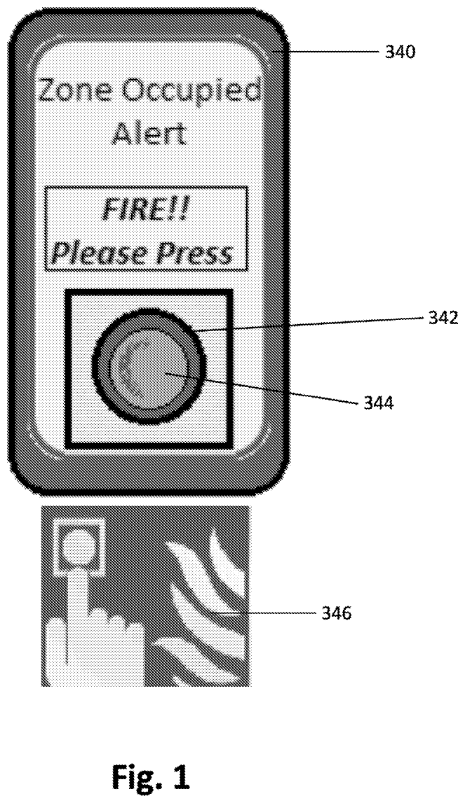

FIG. 1 is a drawing illustrating an exemplary ECD 340 according to an embodiment of the present invention. When a command is received from a fire alarm control panel (FACP), a visual indicator 342 may begin flashing on and off at a human-perceptible rate to catch the attention of any people nearby who, for example, may not be aware that there is an emergency condition, or who may be trapped or handicapped and unable to escape their location. Non-limiting examples of human-perceptible flashing rates include 1 sec. on, 1 sec. off; ½ sec. on, 1 sec. off, etc.

The person in distress, or another person assisting them, may then proceed to an ECD this is nearby, in other words, at distance where the flashing ECD is likely to be noticed by someone needing assistance, or if the ECD has a buzzer, where the buzzer is likely to be noticed. This could be a single ECD in a room for example, or a subset of ECDs different locations within a large room or hall such as an auditorium or gymnasium, or open workplace, such that wherever a person is needing assistance there is at least one ECD close by. The ECD will be fixed to the building in an appropriate location. It might, for example, be walled mounted by which the ECD is fixedly mounted to a wall of the building, or floor-standing by which the ECD is fixedly mounted to the floor of the building.

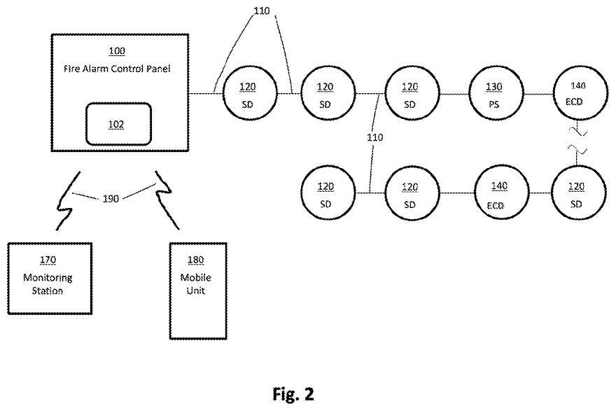

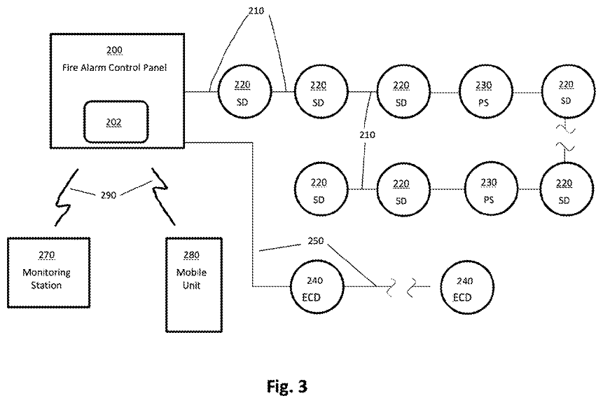

A sign/decal 346 may be posted above, below or next to the ECD to indicate to those present (occupants) that they should press the pushbutton 344 on the ECD. Upon activation of the pushbutton 344, the visual indicator 342 may stop flashing and turn steady on or otherwise change its flash pattern to visually acknowledge the activation; at the same time, the ECD 340 may transmit a message to the FACP, from which the FACP determines that at least one human is present in the vicinity of the activated ECD. The message may be transmitted via a device loop (110 or 250 in FIGS. 2 and 3 respectively) or by a separate wired or wireless medium. The FACP can then display that information on its display screen and/or transmit the information to a central monitoring station and/or mobile units carried by emergency personnel, who then know where to focus their searches.

FIG. 2 is a schematic diagram of a first configuration of a fire detection system employing embodiments of the present invention. A fire alarm control panel (FACP) 100 with an optional graphical screen 102 may communicate over a device loop 110 with various smoke or other hazard detectors 120, as well as manual pull-stations 130. In some system configurations, the FACP 100 may communicate with notification appliances (not shown) such as strobes, horns and speakers on the same device loop 110. Also on the loop 110 may be one or more ECDs (140). The number and types of devices shown in FIGS. 2 and 3 are for exemplary purposes only and are not meant to be limiting.

When the FACP 100 receives information from an initiating device (e.g., detectors 120 and pull-stations 130) indicating that an alarm condition exists, the FACP may determine the location of the alarm condition, from which it may identify those ECDs that may be in the general vicinity of the alarm location. The FACP 100 may then send a command to the identified ECDs to activate, i.e., they begin to flash their visual indicators and monitor their buttons. Alternatively, the FACP could activate all ECDs in a campus area, a subset of a campus, a building, a particular floor of a building, etc.

FIG. 2 further illustrates communication links 190 between the FACP 100 and a monitoring station 170; and between the FACP 100 and a mobile unit 180 such as a smartphone, smartpad or other handheld or mobile device.

FIG. 3 is a schematic diagram illustrating a second configuration of a fire detection system employing embodiments of the present invention. In this embodiment, a fire alarm control panel (FACP) 200 with an optional graphical screen 202 may communicate over a device loop 210 with various smoke or other hazard detectors 220, as well as manual pull-stations 230. In some system configurations, the FACP 200 may communicate with notification appliances such as strobes, horns and speakers (not shown) on the same device loop 210.

Unlike the configuration of FIG. 2, in the configuration illustrated in FIG. 3, one or more ECDs 240 may communicate with the FACP 200 via a separate loop 250. Alternatively, all or some of the ECDs 240 may communicate wirelessly with the FACP 200. The number and types of devices shown on either loop 210/250 are for exemplary purposes only and are not meant to be limiting.

When the FACP 200 receives information from an initiating device (e.g., detectors 220 and pull-stations 230) that an alarm condition exists, the FACP may determine the location of the alarm condition, from which it may identify those ECDs that may be in the general vicinity of the alarm location. The FACP 200 may then send a command to the identified ECDs to activate. Alternatively, the FACP could activate all ECDs in a campus area, a subset of a campus, a building, a particular floor of a building, etc.

FIG. 3 further illustrates communication links 290 between the FACP 200 and a monitoring station 270; and between the FACP 200 and a mobile unit 280 such as a smartphone, smartpad or other handheld or mobile device.

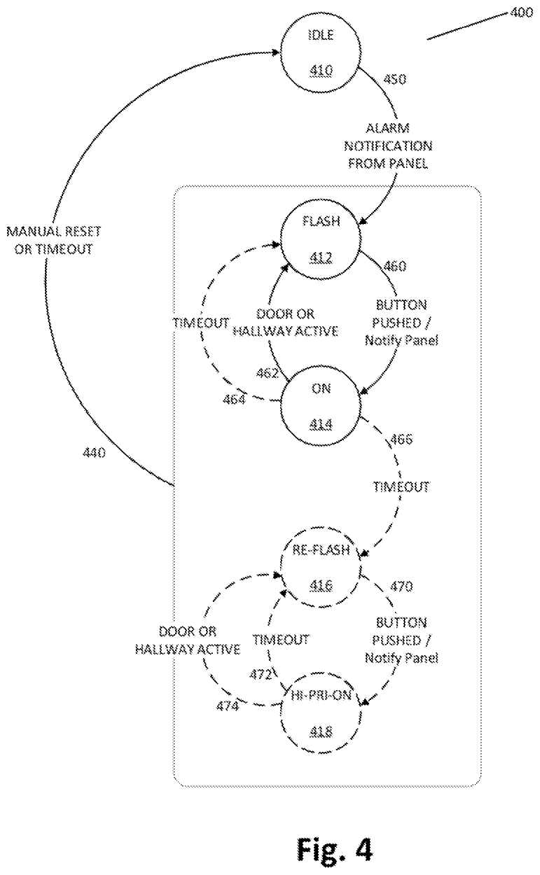

FIG. 4 is a state diagram 400 illustrating the operation of an exemplary ECD.

Normally, the ECD will be in an IDLE state 410, with its visual indicator off, and pressing the button will do nothing. When a fire or other hazard event (e.g., an explosion or active shooter event, etc.) is detected by a controller such as a fire alarm control panel (FACP), the controller will send an activate command signal to at least one ECD in the area of the detected event. The controller may determine the area in which the hazard event has been detected and may send activate command signals to all of the ECDs in that area, or in that area and certain other nearby areas, or a whole building or campus, or even just a single ECD. If the ECD or controller can distinguish between different types of events, for example, fire vs. active shooter, different set or combinations of ECDs may be activated depending on the type of event.

Upon receiving an activation command signal from the controller, a ECD may transition (transition 450) to a FLASH state 412. In this state, the ECD may flash its visual indicator on and off at a human perceptible rate to catch the attention of any nearby occupants.

Of course, the most important action for occupants to do is to get to a safe place. However, if they are unable to, for example, the way is blocked by fire or smoke or doors are locked due to an active shooter event, an occupant may press the button (344 in FIG. 1).

Upon activation of the button, the ECD may send a message to the controller indicating the presence of an occupant nearby who may be trapped or need other assistance, e.g., a disabled person, and transitions (transition 460) to an ON state 414. In this state, the light remains steady on to provide acknowledgement to the occupant that the button activation has been recognized. In a first configuration, the flashing alerts may cease immediately upon activation of the button. In a second configuration, the ECD may wait for an acknowledgement from the controller before stopping the flashing.

When the controller receives the signal indicating a ECD has been activated, i.e., the message indicating the presence of an occupant, it may determine which zone or area that occupant is in and may alert emergency personnel via its front panel and/or by other means such as wired or wireless contact with portable or other equipment configured to receive this message.

At any time in the FLASH 412 or ON 414 states, the ECD may return to the IDLE state 410 upon a manual reset or a timeout (transition 440). A manual reset may be performed at the controller by an operator with authority to perform a reset. Upon a reset operation, the controller may send a reset signal to the ECD and the ECD will revert to the IDLE state and turn its visual indicator off. Alternatively, a manual reset may be performed by a responder at the ECD either with a physical key or by a known sequence of activations on the button; for example, one long push (>3 seconds) followed by 3 short pushes, each less than one second. Finally, the controller or the ECD itself may set a timer wherein if there is no activity for some predetermined time, the ECD reverts to the IDLE state 410.

Alternatively, in a further embodiment as indicated by the dashed transition line 464, rather than reverting to the IDLE state 410 from the ON state 414 when a timeout has occurred, the ECD may transition back to the FLASH state 412 and begin flashing again to alert occupants (if any occupants are still in that area) that the button should be pushed again. The ECD may send a signal to the controller indicating that it has reverted to FLASH state 412.

Alternatively, when a timeout has occurred in the ON state 414, as indicated by dashed transition line 466 the ECD may transition to a high-priority active state RE-FLASH 416, and may again resort to flashing its light, possibly in a different pattern than that used in the FLASH state 412. If an occupant activates the button in this RE-FLASH state 416, the ECD may send a high-priority message to the controller while transitioning (dashed transition line 470) to a high priority HI-PRI-ON state 418. In response, the controller may take some further action to call attention to the zone where the occupant is. In this HI-PRI-ON state 418, the light may stop flashing and stay steady on to acknowledge, or it may execute some other pattern and/or change in color or brightness. On a timeout, rather than reverting back to the IDLE state 410, the HI-PRI-ON state 418 may transition back to the RE-FLASH state 416 (transition 472). The various states and transitions illustrated in FIG. 4 are meant to be exemplary and not limiting.

The ECD may also be equipped with an audible device such as a buzzer or speaker to provide aural notification to nearby occupants to guide blind people toward the ECD. In an embodiment with a speaker, the ECD may have pre-programmed messages to instruct occupants on how to use the ECD and to acknowledge button presses. Buzzers, and any audible sounds may start and stop in parallel with the visual indicator. The ECD may also be equipped with a camera to facilitate communication.

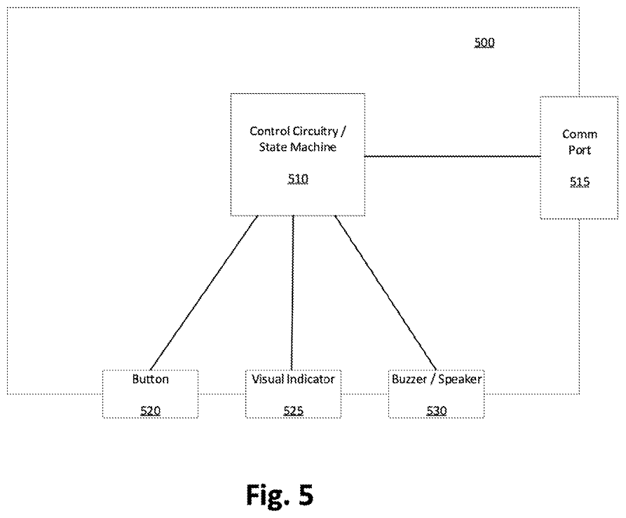

FIG. 5 is a block diagram of a first embodiment of an exemplary ECD 500. Control circuitry 510 communicates with a remote controller such as a fire alarm control panel via a communication port 515. As discussed previously, the communication port may provide communications with the controller via a device loop such as 110 in FIG. 2 or 250 in FIG. 3, or it may communicate over some other wired medium or wirelessly. The control circuitry 500 may comprise hardwired circuitry, a microcontroller, a field programmable gate array (FPGA), an application-specific integrated circuit (ASIC) or other electrical components, or some combination thereof. The control circuitry may require a memory (not shown) in which to store program instructions (such as firmware) to be executed as well as data.

The control circuitry 510 is also in electrical communication with the button 520 (corresponding to 344 in FIG. 1) and visual indicator 525 (corresponding to 342 in FIG. 1), as well as with an optional buzzer and/or speaker 530 so as to control the visual indicator 525 and the buzzer/speaker 530 and to monitor the button 520. A further optional feature (not shown) is a camera.

In a further embodiment of the system, door contacts and external hallway indicators such as motion detectors may communicate with the controller to indicate that occupants have exited from a room, thereby requiring reactivation if occupants are still trapped. Door or hallway activity may cause the ECD to revert from the ON state 414 back to the FLASH state 412 (transition 462) or from the HI-PRI-ON 418 state back to the RE-FLASH state 416 (transition 474).

In yet another embodiment, an intercom facility may be incorporated into some or all ECDs. In some cases, this may require extra wiring or wireless transceivers (not shown).

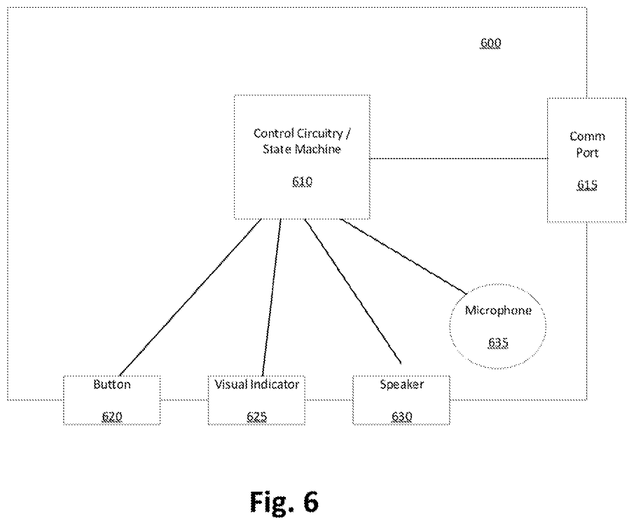

FIG. 6 is a block diagram of a second embodiment of an exemplary ECD 600 having intercom capability. Control circuitry 610 communicates with a remote controller such as a fire alarm control panel via a communication port 615. As discussed previously, the communication port may provide communications with the controller via a device loop such as 110 in FIG. 2 or 250 in FIG. 3, or it may communicate over some other wired medium or wirelessly. The control circuitry 600 may comprise hardwired circuitry, a microcontroller, a field programmable gate array (FPGA), an application-specific integrated circuit (ASIC) or other electrical components, or some combination thereof. The control circuitry may require a memory (not shown) in which to store program instructions (such as firmware) to be executed as well as data.

The control circuitry 610 is also in electrical communication with the button 620 (corresponding to 344 in FIG. 1) and visual indicator 625 (corresponding to 342 in FIG. 1), as well as with a speaker 630 and microphone 635 so as to control the visual indicator 625 and the speaker 630 and to monitor the button 620. The speaker 630 and microphone 635 together may provide 2-way communication between an occupant at the ECD and a person at the panel. A camera (not shown) can also be added.

Multiple ECDs may be placed within a zone for easy and quick access.

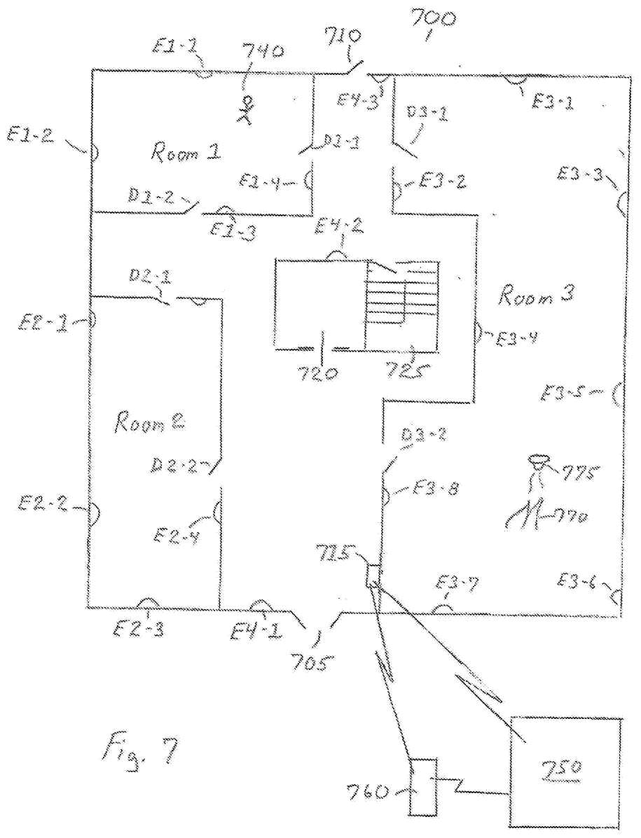

FIG. 7 is a schematic illustrating for exemplary purposes a simple first floor layout of a multi-level building 700. This building has a front entrance 705 and a rear entrance 710. A fire panel 715 is located near the front entrance 705. The building also has an elevator 720 and a stairway 725. The building is also divided into three rooms, for example, office spaces: Room-1, Room-2 and Room-3.

Room-1 has door entrances at D1-1 and D1-2 and four ECDs spaced around the room: E1-1 through E1-4. Similarly, Room-2 has door entrances at D2-1 and D2-2 and five ECDs spaced around the room: E2-1 through E2-5, and Room-3 had entrances at D3-1 and D3-2. Room-3 has door entrances at D3-1 and D3-2 and eight ECDs: E3-1 through E3-8.

Furthermore, E4-1, E4-2 and E4-3 are located respectively near the front entrance, the elevator and staircase, and the rear entrance respectively. Each room and hallway would of course have one or more smoke detectors, but for illustrative purposes here only one smoke detector 775 in Room-3 is shown. Further, it should be understood that the layout of FIG. 7 is for illustrative purposes only. In the real world, there may more or less ECDs distributed throughout a floor, building or campus. As described in the earlier embodiments, the ECDs are fixed to the building in particular locations. For example, they might be wall mounted or floor standing.

Suppose a fire breaks out at location 770 in Room-3. Soon the smoke detector 775 senses smoke and sends a signal to the panel 715, which activates strobes and sounders (not shown), possibly in just the vicinity of the fire's location, or in all of Room-3, or in the whole floor or building. The panel recognizes the location 775 and may identify ECDs in the vicinity of the fire, for example, ECDs E3-5 through E3-8. The panel may send an alarm signal to these identified ECDs and the visual indicator of each of E3-5 through E3-8 may light up, preferably with bright flashes to attract the attention of any occupants in the vicinity. If a particular ECD has a buzzer or speaker, it may also activate that to create a loud sound sufficient to notify an occupant of the ECD's existence and location. A camera can also be included in ECDs.

If an occupant in that area is blocked by smoke and/or door D3-2 is stuck, the occupant will be drawn by at least one of the identified ECDs, and can then activate one of the ECDs, say E3-7 by pushing its pushbutton, switch, touchscreen, etc. Upon activation, this E3-7 will send a signal to the panel 715, which instantly recognizes that an occupant is in trouble near the location of ECD-3.7. An automatic ack signal may be transmitted from the panel to that ECD. Upon receiving the ack signal, the ECD's audible and visual indications may change state upon this activation to indicate that the ECD has been recognized. For example, the visual indicator may stop flashing and show steady, or may flash at a slower rate, and the audible indication may stop.

In addition, automatic messages may be sent to portable communications devices 760 such as smart phones to notify firefighters and other responders, or to a central monitoring station 750, which may then pass the information to the firefighters and responders.

On arrival at the building, firefighters and other responders can access the panel 715 to see where the fire is. A map display will also show the location of the activated ECD (here, E3-7). The firefighter/responder may acknowledge the presence of the distressed occupant, upon which the panel may send another signal to the ECD, which in turn may indicate to the occupant that a person has acknowledged the ECD activation, either again by changing the output mode or state of the visual and audible indicators, or by activating a second visual indicator on the ECD (not shown) if there is one.

Meanwhile, the next day, an occupant 740 in Room-1 is having a medical emergency and unfortunately left his phone in the car. Before collapsing, he is able to approach E1-1 and push the button, even though there is no current alarm. The E1-1 recognizes that the button has been pushed and sends a signal to the panel 715. The panel can respond similarly to how it responded to the fire, possibly sending messages to first responders, ambulances, building management and the like, or calling for emergency assistance to Room-1 on a public address system (not shown). Furthermore, if E1-1 is equipped with a speaker and microphone such as the ECD 600 described in FIG. 6, someone at the panel may establish 2-way communication with the occupant 740, or extend the conversation to a monitoring station or responder. Also, if there is no one at the panel to handle communication with the occupant at the ECD, the message or communication can be diverted to the monitoring centre. Communication can be further enhanced with the optional camera in the ECD.

The terms “light”, “alert light” or “visual indicator” as used herein are synonymous and may include any combination of LEDs, incandescent bulbs, organic LED displays, OCD displays, touchscreens, etc., and may be combined with a button or a touchscreen with a virtual button.

1. An emergency call device arranged to be fitted at a location within a building, comprising:
a visual indicator;
a button;
a communication connection to a hazard alarm panel; and
control circuitry configured to:
in a first state,
maintain the visual indicator in a first visual state, and
upon receiving an alert signal from the hazard alarm panel via the communication connection while in the first state, transition to a second state and cause the visual indicator to transition to a second visual state, and
in the second state, upon detection of the button being activated, transition to a third state, sending a presence signal to the hazard alarm panel of the presence of a person at the location within the building of the device and causing the visual indicator to transition to a third visual state.

2. The emergency call device of claim 1 wherein the communication connection is at least one of wired, wireless and optical.

3. The emergency call device of claim 1 wherein the visual indicator comprises at least one LED.

4. The emergency call device (ECD) of claim 1, wherein upon detection of the button being activated while in the first state, the ECD transmits a signal to the hazard alarm panel, the signal indicating that an occupant close to the ECD needs emergency assistance.

5. The emergency call device (ECD) of claim 1, further comprising an audio station, the audio station comprising a microphone and a speaker, the audio station configured to be enabled by a user action at the hazard alarm panel to enable 2-way audio communication between the ECD and the hazard alarm panel.

6. The emergency call device of claim 1, wherein:
in the first visual state, the visual indicator is steady off,
in the second visual state, the visual indicator to flash at a pre-determined human-perceptible rate, and
in the third state visual state, the visual indicator is steady on.

7. An emergency call system comprising:
at least one emergency call device (ECD), each ECD arranged to be fitted at locations within a building, comprising
a visual indicator;
an actuatable control;
a communication port;
for each ECD, a communication path to communicatively connect said ECD to an alarm panel; and
said alarm panel;
wherein each ECD is configured to, upon actuation of its actuatable control, transmit a first signal to the alarm panel;
wherein the alarm panel is configured to, upon receipt of one or more first signals, display a map indicating the locations within the building of ECDs from which first signals have been received.

8. The emergency call system of claim 7, wherein the actuatable control of each ECD is a button, switch or touchscreen.

9. The emergency call system of claim 7, wherein:
the panel is configured with an acknowledgement control, and is further configured to, upon activation of the acknowledgement control, transmit second signals to ECDs from which first signals originated; and
each ECD is configured to activate its visual indicator upon receipt of a second signal.

10. The emergency call system of claim 7, wherein the panel is configured to detect one or more emergency events.

11. The emergency call system of claim 10, wherein:
the panel is configured to, upon detection of an emergency event at a location, transmit a third signal one or more ECDs close to the location; and
each ECD is configured to activate its visual indicator upon receipt of a third signal.

12. The emergency call system of claim 10, wherein:
the panel is configured to, upon detection of an emergency event at a location, transmit a third signal one or more ECDs close to the location; and
wherein each of one or more of the at least one ECDs further comprises a sound device and is configured to activate its sound device upon receipt of a third signal.

13. The emergency call system of claim 10, wherein an emergency event is any of: a fire alarm; an intruder alarm; and an active shooter alarm.

14. The emergency call system of claim 7, the panel further comprising a communication interface, the panel configured to transmit a message to any of a fireman, a building manager and a central monitoring station.

15. An emergency call device (ECD) arranged to be fitted at a location within a building, comprising:
a visual indicator;
a manual control;
a communication interface to a hazard alarm panel; and
control circuitry configured to:
cause the visual indicator to flash at a pre-determined human-perceptible rate upon receiving an alert signal from the hazard alarm panel, and
transmitting, via the communication interface, a presence signal to the hazard alarm panel of the presence of a person at the location within the building of the device upon detecting activation of the manual control.

16. The ECD of claim 15, the control circuitry further configured to cause the visual indicator to be steady on upon transmitting the presence signal.

17. The ECD of claim 15, wherein the communication interface is at least one of: wired, wireless or optical.

18. The ECD of claim 15 wherein the manual control is a pushbutton.

19. The ECD of claim 15 wherein the visual indicator comprises at least one LED.

20. The ECD of claim 15 further comprising a sound generator, the sound generator comprising at least one of a buzzer or a speaker, the control circuitry further configured to cause the sound generator to sound upon receiving the alert signal from the hazard alarm panel.

21. The ECD of claim 20 wherein the control circuitry is further configured to silence the sound generator upon detecting activation the manual control.

22. A fire alarm system, comprising:
a fire alarm control panel (FACP);
an emergency call device (ECD) fitted at a location within a building; and
a communication link communicatively linking the FACP and the ECD.

23. The fire alarm system of claim 22, the FACP transmitting to the ECD, via the communication link, an alert signal upon the FACP detecting an emergency condition, the ECD comprising:
a visual indicator,
a manual control, and
control circuitry configured to:
cause the visual indicator to flash at a first pre-determined human-perceptible rate upon receiving the alert signal, and
transmitting to the FACP, via the communication link, a presence signal of the presence of a person at the location within the building of the ECD upon detecting activation of the manual control.

24. The fire alarm system of claim 23, wherein upon receiving the presence signal, the FACP provides an indication of a presence of a person at the location of the ECD.

25. The fire alarm system of claim 24, wherein the indication is at least one of: a visual or text display on the FACP; or a transmitted message to any of first responders, firefighters, or a command or monitoring center.

26. The fire alarm system of claim 22, further comprising:
a loop coupled to the FACP communicatively connecting the FACP to initiating devices, wherein the loop also serves as the communication link between the FACP and the ECD.

27. The fire alarm system of claim 22, wherein the ECD is addressable.

28. The fire alarm system of claim 23 further comprising:
at least one of a door monitor and a hallway monitor in communication with the FACP,
the FACP, upon receiving an indication from one of said door and hallway monitors, transmitting a message to the ECD indicating that the control circuitry should cause the visual indicator to flash at a second predetermined rate.

29. A method, comprising the steps of:
detecting, at a fire alarm control panel (FACP), an emergency condition;
upon said detecting, the FACP transmitting an alert signal to at least one emergency call device (ECD) fitted at a location within a building in a vicinity of the detected emergency condition, each ECD comprising
a visual indicator, and
a manual control;
each ECD, upon receiving the alert signal, flashing its respective visual indicator at a pre-determined human-perceptible rate;
each ECD, upon detecting activation of its manual control, transmitting a presence signal to the FACP; and
upon receiving a presence signal from one or more ECDs, the FACP indicating presence of a person at each location within the building from which a ECD transmitted a presence signal.

30. The method of claim 29, wherein the FACP indicates presence by at least one of: displaying text or graphic; or transmitting a message to any of first responders, firefighters, or a command or monitoring center.
